(19) United States
(12) Patent Application Publication
(10) Pub. No.: US 2023/0251401 A1
(43) Pub. Date: Aug. 10, 2023

(54) HYDROPHILIC FILM MANUFACTURING METHOD, HYDROPHILIC FILM, AND OPTICAL MEMBER

(71) Applicant: Konica Minolta, Inc., Chiyoda-ku, Tokyo (JP)

(72) Inventors: Yasushi MIZUMACHI, Hino-shi, Tokyo (JP); Kazunari TADA, Hachioji-shi, Tokyo (JP)

(21) Appl. No.: 18/011,236

(22) PCT Filed: Jun. 7, 2021
(86) PCT No.: PCT/JP2021/021486

§ 371 Date: Dec. 19, 2022

(30) Foreign Application Priority Data
Jun. 23, 2020 (JP) 2020-107415

(51) Int. Cl. G02B 1/18; G02B 1/111; G02B 27/00

(52) U.S. Cl. CPC G02B 1/18; G02B 1/111; G02B 27/0006

(57) ABSTRACT

Provided is a method for manufacturing a hydrophilic film, containing a step of forming a hydrophilic layer mainly composed of SiO₂ on a substrate, wherein at least one hydrophilic layer is formed on the substrate by a wet deposition method so that a layer thickness after drying is 10 nm or less in terms of optical layer thickness, and an arithmetic mean roughness Ra of the hydrophilic film is 3 nm or more.

### TECHNICAL FIELD

The present invention relates to a method for manufacturing a hydrophilic film, a hydrophilic film and an optical member. More particularly, the present invention relates to a method for manufacturing a hydrophilic film having a hydrophilic layer with excellent durability, abrasion resistance, and anti-reflection function, a hydrophilic film, and an optical member.

### BACKGROUND TECHNOLOGY

In recent years, there have been strict requirements for assurance of environmental resistance in optical members such as lenses, antibacterial cover members, anti-mold coating members or mirrors. For example, if the hydrophilic function of a lens deteriorates in a high temperature environment or temperature change (thermal shock), water droplets remain on the lens surface, causing degradation of image visibility.

In addition, water droplets and dirt such as mud often adhere to the lens. Depending on the degree of water droplets adhering to the lens, there is a risk that the image captured by the camera may become unclear. In addition, it is required that the outermost surface layer of the optical member be able to maintain superhydrophilicity when stored in a high temperature and high humidity environment for a long period of time, and a method of providing a durable hydrophilic film on the surface of various optical members has been studied.

Typical methods of forming hydrophilic films include:

(1) A method of forming a hydrophilic film using an inorganic material by a wet deposition method;
(2) A method of forming a hydrophilic film using an organic material by a wet deposition method; and
(3) A method of forming a hydrophilic film using an inorganic material by a dry deposition method.

As formation methods according to (1) and (2) above, for example, Patent Document 1 discloses a method in which an antifogging and antifouling material for an organic substrate containing a specific alcohol solvent and an organosilica sol is brought into contact with or applied to the organic substrate, and the solvent swells the surface of the organic substrate, then an organosilica sol is allowed to penetrate into the swollen surface to form a hydrophilic silica film. According to the method described in Patent Document 1, it is said that an organic substrate having a low water contact angle and excellent in antifouling properties, antifogging properties, adhesion properties and durability can be obtained.

However, when the silica film formed on the surface is applied to an optical member, for example, an in-vehicle camera, there is a risk of surface degradation or deterioration due to salt water contained in sea breeze, acid rain, or chemicals such as detergent or wax used in car washing. For example, the silica (SiO₂) film formed by the wet deposition method as disclosed in Patent Document 1 has low adhesion to the substrate (lens base material), and in a salt spray test SiO₂ dissolves and it is difficult to maintain the above performance. The silica film also has a problem that the adhesion to the substrate is weak and the abrasion resistance is reduced. In addition, since the hydrophilic film formed is manufactured by a wet deposition method, there is a problem in the effectiveness of the hydrophilic film for the anti-reflection function.

Also, in Patent Document 2, an anti-reflection film having a substrate and an antifouling layer (hydrophilic layer) formed by a dense layer and a nanoparticle film having a fine concave-convex structure on the substrate is disclosed, and a method for defining the average roughness of the fine concave-convex structure to a specific range is disclosed. In the method described in Patent Document 2, a method of forming the hydrophilic layer by a wet deposition method is proposed, but the layer thickness of the hydrophilic layer is in the range of 122 to 140 nm, which is a fairly thick film structure, and there was a problem with abrasion resistance.

Therefore, the emergence of a hydrophilic film that satisfies all of the durability, abrasion resistance, and anti-reflective functionality required to maintain a high degree of hydrophilicity when stored in various environments is awaited.

### PRIOR ART DOCUMENTS

### Patent Documents

Patent Document 1: JP-A 2013-203774
Patent Document 2: JP-A 2017-182065

### SUMMARY OF THE INVENTION

### Problem to be Solved by the Invention

The present invention was made in view of the above problems and circumstances, and the problem to be solved is to provide a method for manufacturing a hydrophilic film capable of forming a hydrophilic film having excellent hydrophilicity, durability, abrasion resistance, and anti-reflection function, and a hydrophilic film and optical member.

### Means to Solve the Problems

In order to solve the above problem, in the process of studying the cause of the above problem, the present inventors have developed a method for manufacturing a hydrophilic film, comprising the process of forming a hydrophilic layer mainly composed of SiO₂ on a substrate, wherein at least the hydrophilic layer is formed on the substrate by a wet deposition method so that the layer thickness after drying is 10 nm or less in terms of optical layer thickness, and the arithmetic mean roughness Ra of the hydrophilic film is 3 nm or more. The present inventors have found that this method can realize a method for producing a hydrophilic film excellent in hydrophilicity, durability, scratch resistance, and anti-reflection function, and have achieved the present invention.

In other words, the above problem for the present invention is solved by the following means.

1. A method for manufacturing a hydrophilic film, comprising a step of forming a hydrophilic layer mainly composed of SiO₂ on a substrate, wherein at least one hydrophilic layer is formed on the substrate by a wet deposition method so that a layer thickness after drying is 10 nm or less in terms of optical layer thickness, and an arithmetic mean roughness Ra of the hydrophilic film is 3 nm or more.
2. The method for manufacturing a hydrophilic film according to item 1, wherein the wet deposition method is a spin coating method, a dip coating method, or a spray coating method.
3. The method for manufacturing a hydrophilic film according to item 1 or 2, wherein a protective layer having a layer thickness of 10 nm or less in terms of optical layer thickness is formed on the hydrophilic layer by a dry deposition method.
4. The method for manufacturing a hydrophilic film according to any one of items 1 to 3, wherein the hydrophilic layer contains sodium atoms in the range of 0.1 to 3.0 atm %.
5. The method for manufacturing a hydrophilic film according to any one of items 1 to 4, wherein after forming the hydrophilic layer by a wet deposition method, the hydrophilic layer is subjected to a sintering process at a temperature of 200° C. or higher.
6. The method for manufacturing a hydrophilic film according to any one of items 1 to 5, wherein the protective layer is mainly composed of SiO₂.
7. The method for manufacturing a hydrophilic film according to any one of items 3 to 6, wherein the protective layer is formed by a dry deposition method at a temperature of 200° C. or higher.
8. The method for manufacturing a hydrophilic film according to any one of items 1 to 7, wherein at least one reflectance control layer unit is formed between the substrate and the hydrophilic layer, and an average light reflectance of the hydrophilic film in the wavelength range of 450 to 780 nm is made to be 3.0% or less.
9. The method for manufacturing a hydrophilic film according to item 8, wherein at least one layer constituting the reflectance control layer unit is a sodium-containing layer.
10. The method for manufacturing a hydrophilic film according to item 8 or 9, wherein the reflectance control layer unit on the substrate is composed of:

a first reflectance control layer unit containing at least one low refractive index layer and at least one high refractive index layer; and

a second reflectance control layer unit containing at least a low refractive index layer, a high refractive index layer, and a sodium-containing layer, in that order, and, a layer located at a farthest position from the substrate of the first reflectance control layer unit is a photocatalyst layer containing a metal oxide having a photocatalytic function.

11. The method for manufacturing a hydrophilic film according to item 10, comprising a step of exposing a surface of the photocatalyst layer to form pores.
12. A hydrophilic film having at least a hydrophilic layer on a substrate, wherein the hydrophilic layer is mainly composed of SiO₂, a layer thickness after drying is 10 nm or less in terms of optical layer thickness, and an arithmetic mean roughness Ra of the hydrophilic film is 3 nm or more.
13. The hydrophilic film according to item 12, having a protective layer of 10 nm or less in terms of optical layer thickness on the hydrophilic layer.
14. The hydrophilic film according to item 12 or 13, wherein the hydrophilic layer contains sodium atoms in the range of 0.1 to 3.0 atm %.
15. The hydrophilic film according to any one of items 12 to 14, wherein the protective layer is mainly composed of SiO₂.
16. The hydrophilic film according to any one of items 12 to 15, having at least one reflectance control layer unit between the substrate and the hydrophilic layer, wherein an average light reflectance of the hydrophilic film in the wavelength range of 450 to 780 nm is 3.0% or less.
17. The hydrophilic film according to item 16, wherein at least one layer constituting the reflectance control layer unit is a sodium-containing layer.
18. The hydrophilic film according to item 16 or 17, wherein the reflectance control layer unit is composed of:

a first reflectance control layer unit containing at least one low refractive index layer and at least one high refractive index layer; and

a second reflectance control layer unit containing at least a low refractive index layer, a high refractive index layer, and a sodium-containing layer, in that order, and, a layer located at a farthest position from the substrate of the first reflectance control layer unit is a photocatalyst layer containing a metal oxide having a photocatalytic function.

19. The hydrophilic film according to item 18, having pores which penetrate from an outermost surface layer to an upper surface portion of the photocatalyst layer, and expose a surface of the photocatalyst layer.
20. An optical member provided with the hydrophilic film according to any one of items 12 to 19.
21. The optical member according to item 20, being a lens, an antibacterial cover member, an anti-mold coating member, or a mirror.

### Effects of the Invention

By the above means of the present invention, it is possible to provide a method for manufacturing a hydrophilic film which can form a hydrophilic film with excellent hydrophilicity, durability, abrasion resistance, and anti-reflection function.

The expression mechanism or action mechanism of the effect of the present invention is inferred as follows. In the hydrophilic film of the present invention, as a result of diligent study of the above problem, it was found as follows. As a configuration that can satisfy hydrophilicity, durability, scratch resistance and antireflection function, at least one hydrophilic layer is formed by a wet deposition method so that the layer thickness after drying is 10 nm or less in terms of optical layer thickness, and an arithmetic mean roughness Ra of the hydrophilic film is made to be 3 nm or more.

Conventional hydrophilic films are known to have a hydrophilic layer comprising a nanoporous or nanoparticle film having a fine concave-convex structure on a dense layer, but hydrophilic films having such a structure have the following problems. The first problem is that the nanoporous or nanoparticle film uses a wet deposition method and is deposited as a thick film, so it lacks scratch resistance and has low environmental resistance when used in a harsh environment such as an outdoor camera. The second problem is that the optical properties were not stable due to variations in film thickness during production because the hydrophilic layer was thick.

The present inventors have conducted intensive studies through experiments on methods to achieve high-temperature and high-humidity resistance, heat cycle resistance in harsh environments (thermal shock test) and anti-reflection function. As a result, the present inventors have succeeded in obtaining a hydrophilic layer with excellent hydrophilicity, durability, scratch resistance and anti-reflective function under various environments by forming the hydrophilic layer in a thin film of 10 nm or less using a wet deposition method, and by achieving excellent arithmetic mean roughness Ra.

Generally, when a dry deposition method, for example, a vacuum evaporation method, is applied to form a thin functional layer, only a flat film with few irregularities can be obtained as a surface property, and therefore, the hydrophilic quality required in an outdoor environment cannot be maintained as a heat cycle resistance under a severe environment. In contrast, by applying the wet deposition method, it was found that even if the hydrophilic layer film is 10 nm or less, the desired moderate unevenness structure can be obtained. In addition, by reducing the thickness of the hydrophilic layer to 10 nm or less, it was possible to achieve high adhesion and small manufacturing variation in the anti-reflective performance.

### BRIEF DESCRIPTION OF THE DRAWINGS

FIG. 1 is a cross-sectional view showing an example of the basic configuration of the hydrophilic film of the present invention (Embodiment 1).

FIG. 2 is a perspective view showing an example of a three-dimensional image of the surface of the hydrophilic film of the present invention, measured using an atomic force microscope (AFM).

FIG. 3 is a graph showing a cross-sectional shape in the A-A cut plane of the three-dimensional image measured using the atomic force microscope (AFM) shown in FIG. 2.

FIG. 4 is a schematic diagram of an example of a vacuum deposition system used for the IAD method.

FIG. 5 is a cross-sectional view showing another example of the basic configuration of the hydrophilic film of the present invention (Embodiment 2).

FIG. 6 is a cross-sectional view showing another example of the basic configuration of the hydrophilic film of the present invention (Embodiment 3).

FIG. 7 is a cross-sectional view showing an example of the specific configuration of the first reflectance control layer unit constituting the hydrophilic film.

FIG. 8 is a cross-sectional view showing an example of the specific configuration of the second reflectance control layer unit constituting the hydrophilic film.

FIG. 9 is a flowchart of the process of forming pores in the hydrophilic membrane.

FIG. 10 is a cross-sectional view showing an example of a configuration in which pores are formed in the hydrophilic film to expose the photocatalyst layer. (Embodiment 4).

FIG. 11 is a production flow showing an example of forming pores in a hydrophilic film.

### EMBODIMENTS TO CARRY OUT THE INVENTION

The method for manufacturing a hydrophilic film of the present invention is a method for manufacturing a hydrophilic film comprising a step of forming a hydrophilic layer mainly composed of SiO₂ on a substrate, wherein at least one hydrophilic layer is formed on the substrate by a wet deposition method so that a layer thickness after drying is 10 nm or less in terms of optical layer thickness, and an arithmetic mean roughness Ra of the hydrophilic film is 3 nm or more. This feature is a technical feature common to or corresponding to the following embodiments.

As an embodiment of the present invention, from the viewpoint of expressing the effect of the present invention, it is preferable to apply a spin coating method, a dip coating method, or a spray coating method as a wet deposition method used for forming the hydrophilic layer, because it does not require large-scale thin deposition equipment, has excellent coating film uniformity, and forms a thin film with superior hydrophilicity and optical properties.

In the manufacturing method for the hydrophilic film of the present invention, it is preferable to form a protective layer of 10 nm or less in terms of optical layer thickness on the hydrophilic layer by the dry deposition method, because the protective layer does not fill the uneven structure of the hydrophilic layer in the lower layer and maintains the hydrophilic effect and the hydrophilic effect can be maintained, and a dense thin film can be formed by the dry deposition method to further improve durability and abrasion resistance.

Also, the hydrophilic film of the present invention is a hydrophilic film having at least a hydrophilic layer on a substrate, and the hydrophilic layer is mainly composed of SiO₂ and the layer thickness after drying is 10 nm or less in terms of optical layer thickness, and the arithmetic mean roughness Ra of the hydrophilic film is 3 nm or more. This feature is a technical feature common to or corresponding to the following embodiments.

As the hydrophilic film of the present invention, it is preferred that the hydrophilic layer contains sodium atoms in the range of 0.1 to 3.0 atm % in order to achieve extremely excellent durability (maintaining the hydrophilic effect) in a high temperature and high humidity environment.

After the hydrophilic layer is formed by the wet deposition method, it is preferable to sinter the hydrophilic layer at a temperature of 200° C. or higher to improve the durability and abrasion resistance.

It is preferred that the protective layer be formed at a temperature of 200° C. or higher by a dry deposition method, in that the durability and abrasion resistance are further improved. It is also preferred that the protective layer is mainly composed of SiO₂ in order to obtain excellent durability and hydrophilic effect.

In addition, it is preferable that at least one reflectance control layer unit is formed between the substrate and the hydrophilic layer, and the average light reflectance in the wavelength range of 450 to 780 nm is 3.0% or less in order to obtain a hydrophilic film with excellent light transmittance.

It is also preferred that at least one of the layers constituting the reflectance control layer unit be a sodium-containing layer, because it is possible to express excellent effects of high temperature and high humidity resistance.

In addition, it is also preferred that the hydrophilic layer is provided with as a reflectivity adjustment layer unit, a first reflectivity adjustment layer unit containing at least one low refractive index layer and at least one high refractive index layer, and a second reflectivity adjustment layer unit containing at least a low refractive index layer, a high refractive index layer and a sodium-containing layer on the substrate, in this order. It is preferred that the layer at the furthest position of the first reflectance control layer unit from the substrate is a photocatalyst layer containing a metal oxide having a photocatalytic function, in that an excellent photocatalytic effect can be produced.

It is also preferred to form pores that penetrate from the outermost surface layer of the hydrophilic film to the upper surface portion of the photocatalyst layer and expose the surface of the photocatalyst layer, in order to efficiently produce a better photocatalytic effect.

It is preferred that the hydrophilic film of the present invention is applied to an optical member and the optical member is a lens, an antibacterial cover member, an anti-mold coating member or a mirror, from the viewpoint that the effect of the present invention can be fully expressed.

A detailed description of the present invention, its components, and the form and embodiments for carrying out the present invention will be given below. In this application, “to” is used in the sense of including the numerical values described before and after “to” as lower and upper limits.

### <<Basic Configuration of Hydrophilic Film>>

The hydrophilic film obtained by the method for manufacturing the hydrophilic film of the present invention has a step of forming a hydrophilic layer mainly composed of SiO₂ on a substrate, wherein at least one hydrophilic layer is formed on the substrate by a wet deposition method so that a layer thickness after drying is 10 nm or less in terms of optical layer thickness, and an arithmetic mean roughness Ra of the hydrophilic film is 3 nm or more.

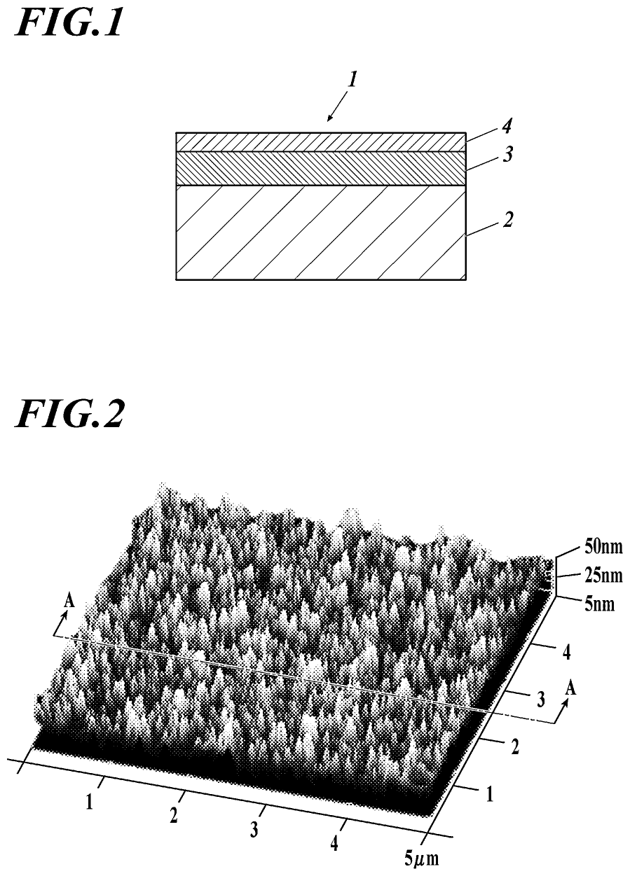

FIG. 1 is a cross-sectional view (Embodiment 1) of an example of a basic configuration of the hydrophilic membrane.

The hydrophilic film 1 shown in FIG. 1 comprises a hydrophilic layer 3 having the characteristics defined in the present invention on a substrate 2, and, in a more preferred form, a protective layer 4 is provided thereon.

### [Arithmetic Mean Roughness Ra]

In the present invention, the arithmetic mean roughness Ra of the hydrophilic film is determined by JIS B 0601-2001 and can be determined using an atomic force microscope. In the present invention, the arithmetic mean roughness Ra is characterized by being 3 nm or more, preferably in the range of 3 to 20 nm, and in the embodiment of forming pores as described below, it is in the range of 20 to 50 nm.

FIG. 2 is a perspective view showing an example of a three-dimensional image of the surface of the hydrophilic film measured using an atomic force microscope (AFM) manufactured by Seiko Instruments Inc. As a method of forming the hydrophilic layer, the conventionally applied dry deposition method fills the uneven structure formed on the surface, and the desired arithmetic mean roughness Ra cannot be obtained. However, by forming a thin hydrophilic layer of 10 nm or less by the wet deposition method, a hydrophilic film with a profile of 3 nm or more can be formed.

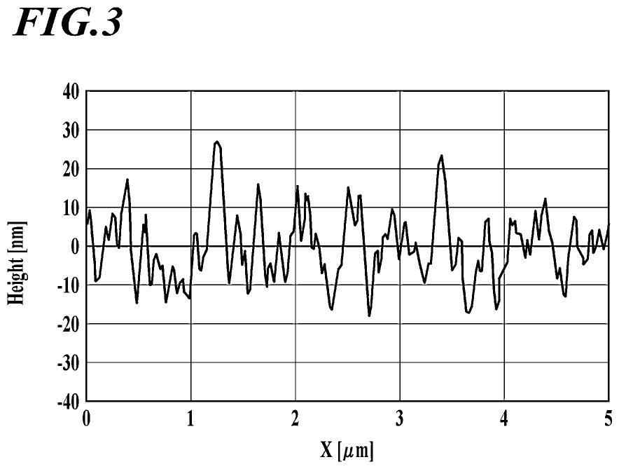

FIG. 3 shows a cross-sectional shape of the hydrophilic film in the A-A cut plane of the three-dimensional image of the hydrophilic film measured using the atomic force microscope (AFM) shown in FIG. 2. The hydrophilic film shown here has an arithmetic mean roughness Ra of 3 nm or more.

### [Hydrophilic Layer]

In the method for manufacturing the hydrophilic film of the present invention, the hydrophilic layer is formed by a wet deposition method so that the layer thickness after drying is 10 nm or less in terms of optical layer thickness, and the arithmetic mean roughness of the hydrophilic film Ra is 3 nm or more.

The hydrophilic layer for the present invention is mainly composed of SiO₂, and the layer thickness after drying is 10 nm or less in terms of optical layer thickness, and it is formed by a wet deposition method so that the layer thickness after drying is 10 nm or less in terms of optical layer thickness.

The term “the hydrophilic layer mainly composed of SiO₂” as used in the present invention means that the ratio of SiO₂ in the total components constituting the hydrophilic layer is 80.0 mass % or more, preferably 90.0 mass % or more and 99.9 mass % or less, and particularly preferably, 97.0 mass % or more and 99.9 by mass % or less.

In the method for manufacturing the hydrophilic film of the present invention, the hydrophilic layer is formed by a wet deposition method, and a spin coating method, a dip coating method or a spray coating method is a preferred form of the wet deposition method for forming the hydrophilic layer.

The hydrophilic layer constituting the hydrophilic film of the present invention will be further described below.

The hydrophilic layer of the present invention is characterized in that it contains SiO₂ as a main component, and it is preferred that it contains sodium atoms in the range of 0.1 to 3.0 atm %.

In the present invention, the sodium content in the hydrophilic layer may be determined by applying a conventionally known analytical method for elemental components.

For example, since the thickness of the hydrophilic layer is extremely thin, one method is to form a single layer of the hydrophilic layer on the substrate in the same way as the formation method of the hydrophilic layer, with a layer thickness of about 200 nm, and this is used as a sample for measuring the sodium content in the hydrophilic layer, and the sodium content can be measured by XPS composition analysis as described below.

### (XPS Composition Analysis)

Name of apparatus: X-ray photoelectron spectrometer (XPS)

Apparatus type: Quantera SXM

Apparatus manufacturer: ULVAC Phi

Measurement conditions: X-ray source=monochromatized AlKα beam 25 W-15 kV

Vacuum degree: 5.0×10⁻⁸ Pa

Another method is to form a hydrophilic layer on the silicon substrate at a predetermined layer thickness, and then measure the sodium content by XPS composition analysis in the same way as described above.

Specifically, the hydrophilic layer of the present invention contains SiO₂ as a main component and, if necessary, it is preferable that sodium atoms as an element whose electronegativity is smaller than that of Si are contained in the range of 0.1 to 3.0 atm % as described above.

With respect to the durability (maintaining of hydrophilicity) of the hydrophilic layer containing SiO₂ under high temperature and high humidity (85° C. and 85% RH), the hydrophilic layer of the present invention contains sodium atoms as elements whose electronegativity is smaller than Si, and the hydrophilic function is further improved by this, and a hydrophilic film with a low water contact angle may be formed. In contrast to the case of pure SiO₂, SiO₂ incorporating sodium atoms is considered to develop polarity in the arrangement of electrons, which may have affinity to H₂O, which is a polar molecule. In other words, the electronegativity difference between sodium atom and O is larger than the electronegativity difference between Si and O, which causes the electrical bias. In particular, Na₂O, which is a sodium oxide, has a melting point relatively close to that of SiO₂, and therefore has the advantage of being easy to form a film simultaneously with SiO₂ as a mixed vapor deposition material. There is little deviation in terms of the composition ratio of the vapor-deposited film.

When sodium atoms are contained, NaOH derived from sodium has a property of taking water from the external environment to become an aqueous solution because of its deliquescence. It is assumed that the hydrophilic property may be maintained for a long period of time by taking water in a high temperature and high humidity environment.

Although there is no particular restriction as a material for forming a hydrophilic layer containing sodium atoms for the present invention, for example, a commercially available product such as EXCELPURE “BD-S01” manufactured by Central Automotive Products Ltd. is preferable as a commercially available product.

In the method for manufacturing the hydrophilic film of the present invention, the hydrophilic layer is formed by a wet deposition method.

There are no particular limitations on wet deposition methods applicable to the present invention. Examples thereof include a spin coating method, a spray coating method, a dip coating method, a flow coating method, a bar coating method, a reverse coating method, a flexographic method, a printing method, an inkjet printing method, and methods using a combination of these methods. In the present invention, a spin coating method, a dip coating method or a spray coating method is particularly preferred in terms of uniformity of the thin hydrophilic layer, control of the film thickness, and the ability to obtain the desired arithmetic mean roughness Ra of the hydrophilic film. The desired film thickness control of the hydrophilic layer may be controlled, for example, by adjusting the substrate rotation speed and the concentration of the hydrophilic layer forming material when the spin coating method is applied.

In the present invention, after forming the hydrophilic layer by the wet deposition method, it is preferable to sinter the hydrophilic layer at a temperature of 200° C. or higher to improve the durability and abrasion resistance.

### (Method of Forming Hydrophilic Layer)

The hydrophilic layer of the present invention may be formed, for example, by a spin coating method, which is a wet deposition method as described below.

### (A) Constituent Material: Hydrophilic Material Composed of SiO₂ Including Na

Product name: EXCELPURE “BD-S01” manufactured by Central Automotive Products Ltd.

### (B) Hydrophilic Layer Formation Method: Spin Coating Method

(1) Dilute EXCELPURE to an arbitrary concentration. For example, when the layer thickness is 10 nm and the arithmetic mean roughness Ra of the hydrophilic film is 3 nm or more, it is diluted to ratio of EXCELPURE to ethanol=1:8 (mass ratio).

(2) Supply 50 μL of the above solution on the substrate or the reflectance control layer unit.

(3) Form hydrophilic layer by a spin coating method at room temperature and 3000 rpm rotation speed.

(4) After the layer is formed, heat treatment is applied at 370° C. for 30 minutes.

### [Protective Layer]

In the method for manufacturing the hydrophilic film of the present invention, a protective layer of 10 nm or less in terms of optical layer thickness is preferably formed on the hydrophilic layer according to the present invention by a dry deposition method, and furthermore, it is a preferred embodiment to form the layer at a temperature of 200° C. or higher. It is also preferred that the protective layer of the present invention contains SiO₂ as a main component.

### (Characteristics of Protective Layer and Hydrophilic Layer)

The protective layer for the present invention is preferably provided with the following characteristics.

In the form in which the hydrophilic film of the present invention is composed of the above hydrophilic layer and a protective layer, it is preferred that the density of the protective layer is higher than the density of the hydrophilic layer. In more detail, the packing density of the protective layer is preferably 0.95 or more, and further, the packing density of the protective layer is more preferably 0.98 or more. On the other hand, the packing density of the hydrophilic layer density of the hydrophilic layer is preferably less than 0.95, and more preferably it is less than 0.90.

The packing density of each of these layers may be determined by depositing a single film of each on a Si substrate with a thickness of 100 nm, followed by performing optical evaluation. The cross section of the hydrophilic film may also be measured by TEM observation.

In the hydrophilic film of the present invention, the composition of the protective layer is not particularly limited except that it is mainly composed of SiO₂, but the sodium content is preferably less than 15 atm %, and more preferably it is in the range of 0.1 to 15 atm %.

The sodium content in the protective layer according to the present invention may be determined by applying the same method as the method for measuring the sodium content of the hydrophilic layer described above. That is, a protective layer is deposited on a silicon substrate with a thickness of 100 nm, and the XPS method is applied for measurement. As another method, it may be measured using a 3D atom probe method.

For example, as the surface composition of the hydrophilic film, which is a laminate composed of a substrate/reflectance control layer unit/hydrophilic layer/protective layer in that order, the sodium content is preferably in the range of 0.1 to 15 atm %, and more preferably in the range of 0.1 to 10 atm %.

For example, the materials constituting the protective layer according to the present invention include SiO₂ or SiO₂—Na₂O.

As the layer thickness of the protective layer according to the present invention, it is preferred that the thickness is 10 nm or less, more preferably in the range of 1 to 10 nm, and even more preferably in the range of 2 to 6 nm.

Although there are no particular limitations on the method of forming the protective layer according to the present invention, it is preferable to form the protective layer by a dry deposition method, such as a vacuum evaporation method, an ion beam evaporation method, an ion plating method, and in the sputtering system, a sputtering method, an ion beam sputtering method, a magnetron sputtering method. Among them, an ion-assisted deposition method (hereinafter also referred to as “IAD” in the present invention) or a sputtering method is preferred.

### (Ion-Assisted Deposition (IAD) Method)

The IAD method is a method to make a dense film by applying the high kinetic energy of ions during deposition to increase the adhesion of the film. For example, the ion beam method is a method in which the adhered material is accelerated by ionized gas molecules irradiated from an ion source and deposited on the substrate surface.

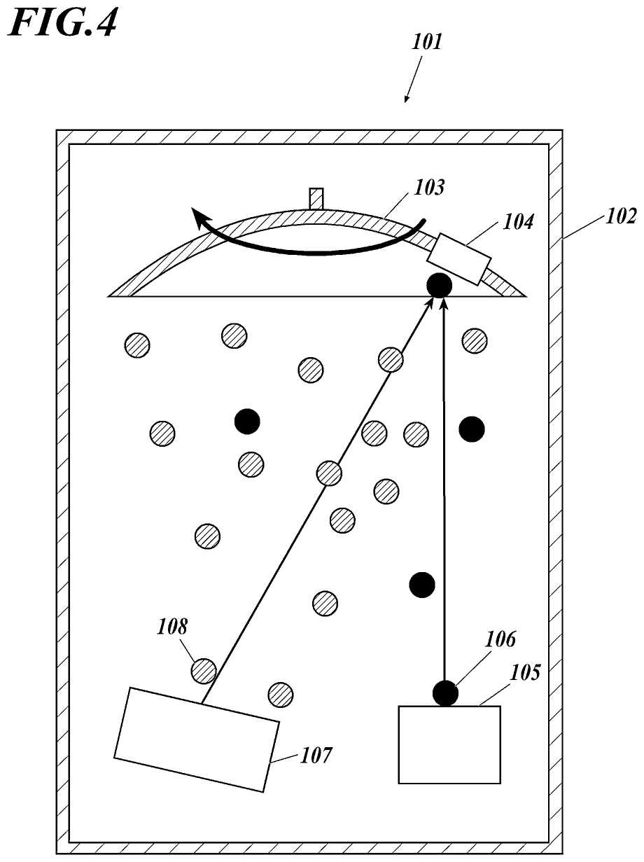

FIG. 4 shows a schematic diagram of a vacuum deposition apparatus using the IAD method, which is an example of a protective layer formation method.

The vacuum deposition apparatus 101 using the IAD method shown in FIG. 4 (hereinafter also referred to as an IAD deposition apparatus) is equipped with a dome 103 in a chamber 102, and a substrate 104 is arranged along the dome 103. The deposition source 105 is equipped with an electron gun or a resistance heating device for evaporating a deposition substance, and the deposition material 106 is dispersed from the deposition source 105 toward the substrate 104 and condenses and solidifies on the substrate 104. At that time, an ion beam 108 is irradiated toward the substrate from the IAD ion source 107, and the high kinetic energy of the ions is applied during deposition to create a dense film and to increase the adhesion of the film.

The substrate 104 used in the present invention is glass, or resins such as polycarbonate resin or cycloolefin resin, and it is preferably an automotive lens.

A plurality of deposition sources 105 are arranged at the bottom of the chamber 102. Although one deposition source is shown here as the deposition source 105, there may be multiple deposition sources 105. The deposition material 106 is generated from the deposition material (evaporation material) in the evaporation source 105 by an electron gun or resistance heating. By scattering and adhering the film forming material to the substrate 104 placed in the chamber 102, the deposition material for the protective layer, e.g., SiO₂, is formed on the substrate 104.

When forming a protective layer containing SiO₂ according to the present invention, it is preferable that SiO₂ target is arranged in the evaporation source 105 to form a film containing SiO₂ as a main component.

The chamber 102 is also provided with a vacuum exhaust system, not shown, by which the chamber 102 is evacuated. The degree of pressure reduction in the chamber is usually in the range of 1×10⁻⁴ to 1×10⁻¹ Pa, preferably in the range of 1×10⁻³ to 1×10⁻² Pa.

The dome 103 holds at least one holder (not shown) that holds the substrate 104 and is also referred to as a deposition umbrella. The dome 103 is arc-shaped in cross-section and has a rotationally symmetric shape that rotates about an axis of rotational symmetry that passes through the center of a string connecting the ends of the arc and is perpendicular to the string. When the dome 103 rotates around the axis at a constant speed, for example, the substrate 104 held by the dome 103 via the holder revolves around the axis at a constant speed.

The dome 103 may hold a plurality of holders side-by-side in the rotation radial direction (orbital radial direction) and in the rotation direction (orbital direction). This makes it possible to simultaneously deposit a film on a plurality of substrates 104 held by the plurality of holders, thereby improving the manufacturing efficiency of the laminate.

The IAD ion source 107 introduces argon gas and oxygen gas into the body to ionize them, and then ionizes the ionized gas molecules (ion beam 108) towards the substrate 104. Argon gas and oxygen gas are also used as neutralizers that electrically neutralize the positive charge accumulated on the substrate in order to prevent a phenomenon in which the entire substrate becomes positively charged (so-called charge-up) due to the accumulation of positive ions irradiated from the ion gun on the substrate.

As ion sources, Kaufmann type (filament), hollow cathode type, RF type, bucket type, and duo Plasmatron type may be applied. By irradiating the substrate 104 with the above gas molecules from the IAD ion source 107, for example, the molecules of the film forming material evaporated from a plurality of evaporation sources may be pressed against the substrate 104, and a film with high adhesion and high density may be formed on the substrate 104. The IAD ion source 107 is located at the bottom of the chamber 102 facing the substrate 104, but it may be installed at a position deviated from the opposing axis.

In the IAD method, for example, an ion beam with an acceleration voltage of 100 to 2000 V, an ion beam with a current density of 1 to 120 μA/cm², or an ion beam with an acceleration voltage of 500 to 1500 V and a current density of 1 to 120 μA/cm² may be used. In the deposition process, the irradiation time of the ion beam may be from 1 to 800 seconds, for example, and the number of particle irradiations of the ion beam may be from 1×10¹³ to 5×10¹⁷ particles/cm². The ion beam used in the deposition process may be an ion beam of oxygen, an ion beam of argon, or an ion beam of a mixed gas of oxygen and argon. In the present invention, it is preferable to deposit the film under a gas introduction rate of 5 sccm or higher. For example, the oxygen introduction amount is preferably in the range of 30 to 60 sccm. The term “sccm” is an abbreviation for “standard cc/min”. It is a unit that indicates the amount (cc) of the gas flowed per minute at 1 atm (atmospheric pressure 10¹³ hPa) and 0° C. The monitor system (not shown) is a system that monitors the wavelength characteristics of the layers deposited on the substrate 104 by monitoring the layers that evaporate from the deposition sources 105 and adhere to itself during vacuum deposition. With this monitor system, it is possible to grasp the optical properties (for example, spectral transmittance, light reflectance, and optical layer thickness) of the layer formed on the substrate 104. The monitoring system also includes a quartz layer thickness monitor, which can monitor the physical layer thickness of the layer deposited on the substrate 104. This monitor system also functions as a control unit that controls ON/OFF switching of the plurality of evaporation sources 105 and ON/OFF switching of the IAD ion source 107, according to the layer monitoring results.

### (Sputtering Method)

For deposition by sputtering method, two-pole sputtering, magnetron sputtering, dual magnetron sputtering (DMS) using intermediate frequency regions, ion beam sputtering, and ECR sputtering may be used alone or in combination of two or more types. The application method to the target is selected according to the target species, and either DC (direct current) sputtering or RF (radio frequency) sputtering may be used.

The sputtering method may be a multiple simultaneous sputtering method using a plurality of sputtering targets. Regarding to the methods for fabricating these sputtering targets and the methods for fabricating thin films using these sputtering targets, descriptions, for example, in JP-A 2000-160331, JP-A 2004-068109, JP-A 2004-068109, and JP-A 2013-047361, may be referred to as appropriate.

### (Specific Formation Method of Protective Layer)

The protective layer according to the present invention may be formed, for example, according to the following method.

(A) Forming material: made by Toshima Corporation, Product name: SiO₂—Na₂O (Na content: 10.0 atm %)
(B) Deposition process: IAD method

(1) A vacuum evaporation apparatus (IAD method) is used, and the conditions are as follows: the temperature is set to 370° C., and the vacuum degree is set to 7.5×10⁻³ Pa or less.

(2) Using the above formation material SiO₂, a film is deposited at a deposition rate of 0.5 to 5 Å/sec.

(3) When the layer thickness of the protective layer becomes 10 nm or less, the film deposition is stopped.

### [Substrate]

As a substrate 2 applicable to the present invention, there is no particular limitation, for example, it is preferably made of an inorganic material, an organic material or a combination thereof. Inorganic materials include glass, fused quartz glass, synthetic quartz glass, silicon or chalcogenide. Organic materials include cycloolefin polymers (COP), cycloolefin copolymers (COC), polymethyl methacrylate resin (PMMA), polycarbonate resin (PC), polypropylene (PP), and polyethylene (PE). UV curable resins include radical polymerization type acrylate resins, urethane acrylates, polyester acrylates, polybutadiene acrylates, epoxy acrylates, silicone acrylates, amino resin acrylates, thiol-ene resin, cationic polymerization type vinyl ether resin, alicyclic epoxy resin, glycidyl ether epoxy resin, urethane vinyl ether, and polyester vinyl ether. Thermosetting resins include epoxy resin, phenol resin, unsaturated polyester resin, urea resin, melamine resin, silicone resins, and polyurethane. The substrate 2 may be formed by forming a film made of an organic material on an inorganic material such as glass.

### <<Other Embodiments of the Hydrophilic Film of the Present Invention>>

Details of other embodiments of the hydrophilic film of the present invention will now be described.

### Embodiment 2

In a preferred embodiment of the present invention, there is at least one reflectance control layer unit U between the substrate and the hydrophilic layer, and an average light reflectance in the range of 450 to 780 nm is made to be 3.0 nm or less.

FIG. 5 is a cross-sectional view of another example of the basic configuration of the hydrophilic film of the present invention (Embodiment 2).

The hydrophilic film 1 shown in FIG. 5 is provided on the substrate 2 with a reflectance control layer unit U having an average light reflectance of 3.0% or less in the wavelength range of 450 to 780 nm. A hydrophilic layer 3 is formed thereon, and a protective layer 4 is provided on the upper layer side of the hydrophilic layer 3.

In the hydrophilic film 1 of the present invention, as described above, the hydrophilic layer 3 is formed by the wet deposition method so that the layer thickness is 10 nm or less in terms of optical layer thickness. The basic configuration is to have at least one protective layer 4 on the upper layer side of the hydrophilic layer 3, and more specifically, the following layer arrangement may be mentioned.

Specific layer arrangements are as follows:

(1) A configuration in which a protective layer 4 is disposed in a position directly adjacent to the surface side of the hydrophilic layer 3 of the present invention;
(2) A configuration having a protective layer 4 on the surface side of the hydrophilic layer 3, and an intermediate layer is disposed between the hydrophilic layer 3 and the protective layer 4; and
(3) A configuration in which multiple sets of units comprising a hydrophilic layer 3 and a protective layer 4 are stacked.

### Embodiment 3

In the present invention, the reflectance control layer unit U shown in FIG. 5 comprises a first reflectance control layer unit 5 containing at least one low refractive index layer and at least one high refractive index layer, and a second reflectance control layer unit 6 containing at least a low refractive index layer, a high refractive index layer and a sodium-containing layer, in that order, and further, in the first reflectance control layer unit 5, the layer located at the furthest position from the substrate is preferably a photocatalyst layer containing a metal oxide having a photocatalytic function, for example, TiO₂.

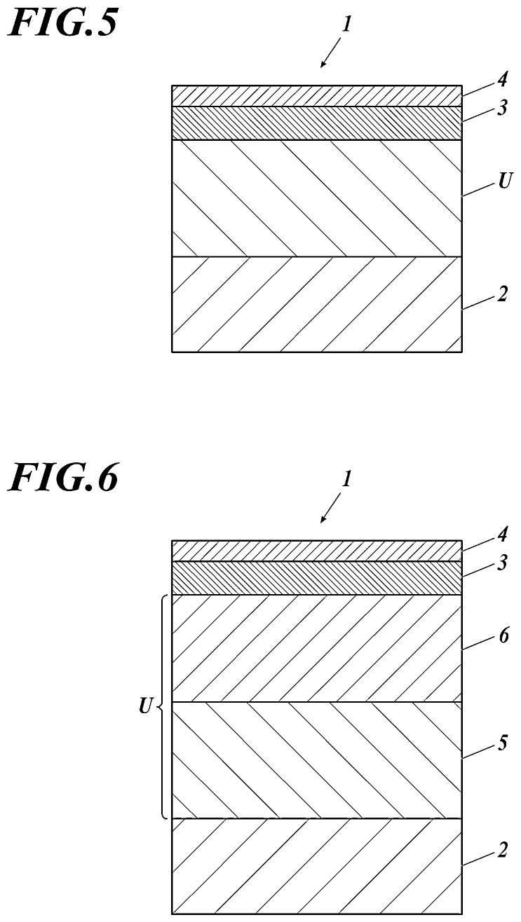

FIG. 6 is a cross-sectional view of another configuration of the hydrophilic film of the present invention 1 (Embodiment 3).

The configuration shown in FIG. 6 illustrates an example in which the reflectance control layer unit U shown in FIG. 5 above comprises a first reflectance control layer unit 5 and a second reflectance control layer unit 6.

### (First Reflectance Control Layer Unit 5)

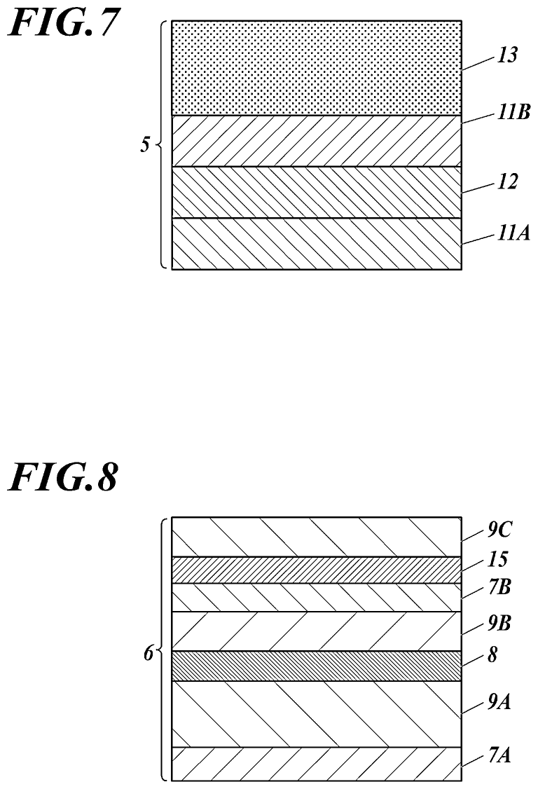

FIG. 7 is a cross-sectional view showing an example of a specific configuration of the first reflectance control layer unit constituting the hydrophilic film 1 described in FIG. 6.

An example configuration of the first reflectance control layer unit 5 shown in FIG. 7 comprises the following first low refractive index layer 11A, high refractive index layer 12, a second low-refractive-index layer 11B, and a photocatalyst layer 13.

(1) First low refractive index layer 11A: Constituent material=SiO₂, Layer thickness=22 nm
(2) High refractive index layer 12: Constituent material=Ta₂O₅—TiO₂, Layer thickness=18 nm
(3) Second low refractive index layer 11B: Constituent material=SiO₂, Layer thickness=33 nm
(4) Photocatalyst layer 13: Constituent material=TiO₂, Layer thickness=112 nm

Next, the details of each constituent of the first reflectance control layer unit will be described.

### (First Low Refractive Index Layer 11A and Second Low Refractive Index Layer 11B)

The first and second low refractive index layers according to the present invention comprise a material having a refractive index of less than 1.7, and in the present invention, these layers preferably contain SiO₂ as a main component. However, it is also preferable to contain other metal oxides, such as a mixture of SiO₂ and some Al₂O₃ or MgF₂ from the viewpoint of light reflectance.

### <High Refractive Index Layer 12>

In the present invention, the high refractive index layer comprises a material with a refractive index of 1.7 or higher. It is preferable to be a mixture of an oxide of Ta and an oxide Ti, or an oxide of Ti, an oxide of Ta, or a mixture of an oxide of La and an oxide of Ti. It is more preferred that the metal oxide used for the high refractive index layer has a refractive index of 1.9 or higher. In the present invention, it is preferred to be Ta₂O₅ or TiO₂, and more preferably it is Ta₂O₅.

In the present invention, the thickness of the first reflectance control layer unit containing a high refractive index layer and a low refractive index layer is not particularly limited, but from the viewpoint of anti-reflective performance, a thickness of 500 nm or less is preferable, and more preferably, it is in the range of 50 to 500 nm. If the thickness is 50 nm or more, the optical property of anti-reflection may be exhibited. If the thickness is 500 nm or less, the error sensitivity may be reduced and non-defective ratio of the lens for the spectral characteristics may be improved.

### <Photocatalyst Layer 13>

In the first reflectance control layer unit 5 of the present invention, a photocatalyst layer having a photocatalytic function is preferably provided as the outermost surface layer.

The photocatalyst layer of the present invention is preferably composed of TiO₂ as a metal oxide having a photocatalytic function and is preferred in that it has a high refractive index and can reduce the light reflectance of the dielectric multilayer film.

The “photocatalytic function” in the present invention refers to the organic matter decomposition effect by photocatalyst. This is because when TiO₂ having photocatalytic properties is irradiated with ultraviolet light, active oxygen and hydroxyl radicals (·OH radicals) are generated after electrons are released, and the strong oxidizing power decomposes organic matter. By adding a functional layer containing TiO₂ to the dielectric multilayer film of the present invention, it is possible to prevent organic matter adhering to the optical member from contaminating the optical system as dirt.

Whether it has a photocatalytic effect or not may be determined as follows. For example, in an environment of 20° C. and 80% RH, a sample colored with a pen is irradiated with ultraviolet light at a cumulative light amount of 20 J, and the color change of the pen is evaluated step by step. As a specific photocatalytic performance test method, for self-cleaning by UV light irradiation, for example, the methylene blue degradation method (ISO 10678 (2010)) and Resazurin ink degradation method (ISO 21066 (2018)) may be mentioned.

In the present invention, as the reflectance control layer unit, a first reflectance control layer unit composed of at least one low refractive layer and at least one high refractive index layer, and a second reflectance control layer unit composed of a low refractive index layer, a high refractive index layer and a sodium-containing layer are provided on the substrate in this order. After forming a hydrophilic film having a configuration in which the layer farthest from the substrate in the first reflectance control layer unit is a photocatalyst layer containing a metal oxide having a photocatalytic function, as will be described later, it is configured to have pores that penetrate at least from the layer below the hydrophilic layer to the upper surface of the photocatalyst layer and expose the surface of the photocatalyst layer. By this configuration, the photocatalytic effect is expressed.

### (Second Reflectance Control Layer Unit 6)

FIG. 8 shows an example of a specific configuration of the second reflectance control layer unit constituting the hydrophilic film.

In the present invention, the second reflectance control layer unit 6 preferably contains at least a low refractive index layer, a high refractive index layer, a salt spray protection layer and a sodium-containing layer.

In the configuration example of the second reflectance control layer unit 6 described in FIG. 8, an example of a configuration in which each of the following constituent layers (7 layers) are stacked from the bottom (substrate side) is shown.

(1) Low refractive index layer 7A: Constituent material=SiO₂, Layer thickness=14 nm
(2) Sodium-containing layer 9A: Constituent material=SiO₂—Na₂O, layer thickness=14 nm
(3) High refractive index layer 8: Constituent material=TiO₂, Layer thickness=1 nm
(4) Sodium-containing layer 9B: Constituent material=SiO₂—Na₂O, layer thickness=29 nm
(5) Low refractive index layer 7B: Constituent material=SiO₂, Layer thickness=1 nm
(6) Salt spray protection layer 15: Constituent material=TiO₂, Layer thickness=1 nm
(7) Sodium-containing layer 9C: Constituent material=SiO₂—Na₂O, layer thickness=3 nm

The salt spray protection layer here is a layer that has the function of preventing damage to the lower layer by salt water in a salt spray test.

By providing the above second reflectance control layer unit 6 between the first reflectance control layer unit 5 and the hydrophilic layer 3/protective layer 4, the hydrophilic film average light reflectance may be controlled to a desired condition, for example, 3.0% or less.

### (Method of Forming the Reflectance Control Layer Unit Component Layer)

### (Deposition Method of Sodium-Containing Layer and Salt Spray Protection Layer)

In the method of forming the hydrophilic film of the present invention, regarding to the deposition method of the first reflectance control layer unit containing a low refractive index layer and a high refractive index layer, the second reflectance control layer unit containing a low refractive index layer, a high refractive index layer, a salt spray protection layer and a sodium-containing layer, there is no particular limitation, but it is preferred that the dry deposition method is used.

Dry deposition methods applicable to the present invention include a vacuum deposition method, an ion beam deposition method, and an ion plating method for the deposition system, and a sputtering method, an ion beam sputtering method, and a magnetron sputtering method for the sputtering system. Among them, the aforementioned Ion Assisted Deposition (IAD) method or the sputtering method is preferred.

### <<Pore Formation>>

In the hydrophilic film of the present invention, a first reflectance control layer unit containing at least one low refractive index layer and at least one high refractive index layer and a second reflectance control layer unit containing at least a low refractive index layer, a high refractive index layer and a sodium-containing layer are provided as a reflectance control layer unit on the substrate in this order, wherein the layer at the furthest position from the substrate of the first reflectance control layer unit is a photocatalyst layer containing a metal oxide having a photocatalytic function, and pores are formed so as to penetrate from at least the layer below the hydrophilic layer to the upper surface of the photocatalyst layer and to expose the surface of the photocatalyst layer. This is one of preferred embodiments.

First, the manufacturing process flow of forming pores in the hydrophilic film of the present invention will be described with reference to figures.

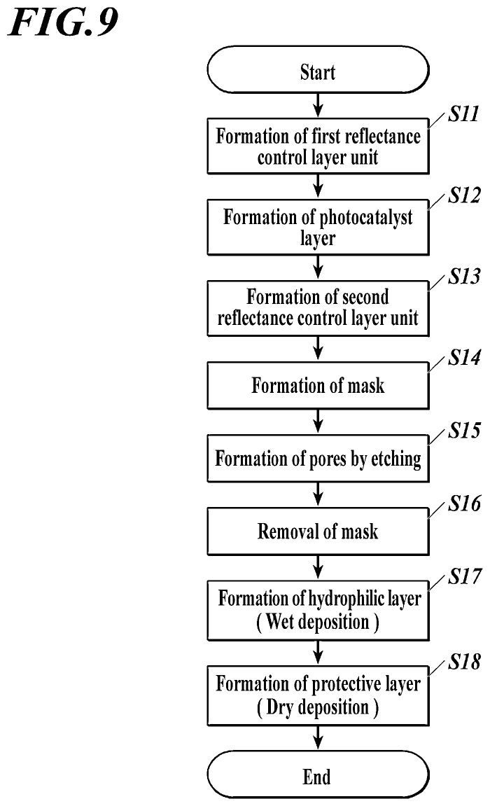

FIG. 9 is a flowchart showing an example of the steps of manufacturing the hydrophilic film and forming the pores. The present invention is not limited to the manufacturing method described below.

### (Step S11)

A first reflectance control layer unit 5 containing a low refractive index layer and a high refractive index layer is formed on the substrate 2 by a dry deposition method, for example.

### (Step S12)

Further, a photocatalyst layer 13 is formed on the outermost surface layer of the first reflectance control layer unit 5 by a dry deposition method.

### (Step S13)

Next, on the photocatalyst layer 13 constituting the first reflectance control layer unit 5, a second reflectance control layer unit 6 containing a low refractive index layer, a high refractive index layer, a salt spray protection layer and a sodium-containing layer is formed by a dry deposition method.

### (Step S14)

Next, a mask 10 is formed on the second reflectance control layer unit 6. The mask 10 is, for example, a metal mask constituting a metal portion and an exposed portion.

### (Step S15)

Then, through the mask 10, an etching apparatus is used from the surface side to form pores 14 that penetrate from the outermost surface layer to the upper surface of the photocatalyst layer 13 by etching to expose the surface of the photocatalyst layer.

### (Step S16)

Next, the mask 10 formed on the surface is removed.

### (Step S17)

Next, the hydrophilic layer 3 having an optical layer thickness of 10 nm or less is formed on the second reflectance control layer unit 6 with the pores 14 formed thereon by using a wet deposition method such as a spin coating method.

### (Step S18)

Finally, a protective layer having a layer thickness of 10 nm or less in terms of optical layer thickness is formed on the hydrophilic layer 3 using a dry deposition method such as an IAD method.

Next, the specific composition of the hydrophilic film with pores will be described.

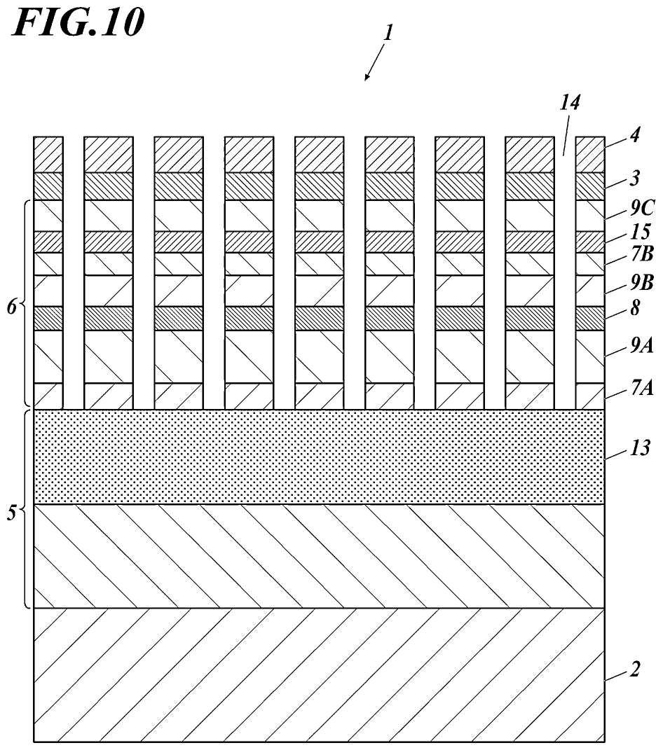

FIG. 10 is a cross-sectional view (Embodiment 5) showing an example of a configuration in which pores are formed in the hydrophilic film to expose the photocatalyst layer.

As shown in FIG. 10, according to the method of forming the hydrophilic film described above, a first reflectance control layer unit 5 having a photocatalyst layer 13 as the uppermost layer is formed on the substrate 2. Next, the second reflectance control layer unit 6 is laminated thereon, and the hydrophilic layer 3 and the protective layer 4 are laminated thereon to form the hydrophilic film 1 shown in FIG. 6.

In the present invention, after stacking the second reflectance control layer unit 6, a reactive etching process or a physical etching process is used with a mask to form pores 10 that penetrate from the outermost surface layer to the upper surface of the photocatalyst layer 13 and expose the surface of the photocatalyst layer. Finally, the hydrophilic layer 3 and the protective layer 4 are laminated to produce the hydrophilic film. By forming the pores in this configuration, an excellent photocatalytic function is expressed.

The manufacturing flow of the pores according to the present invention will be described with reference to figures as follows.

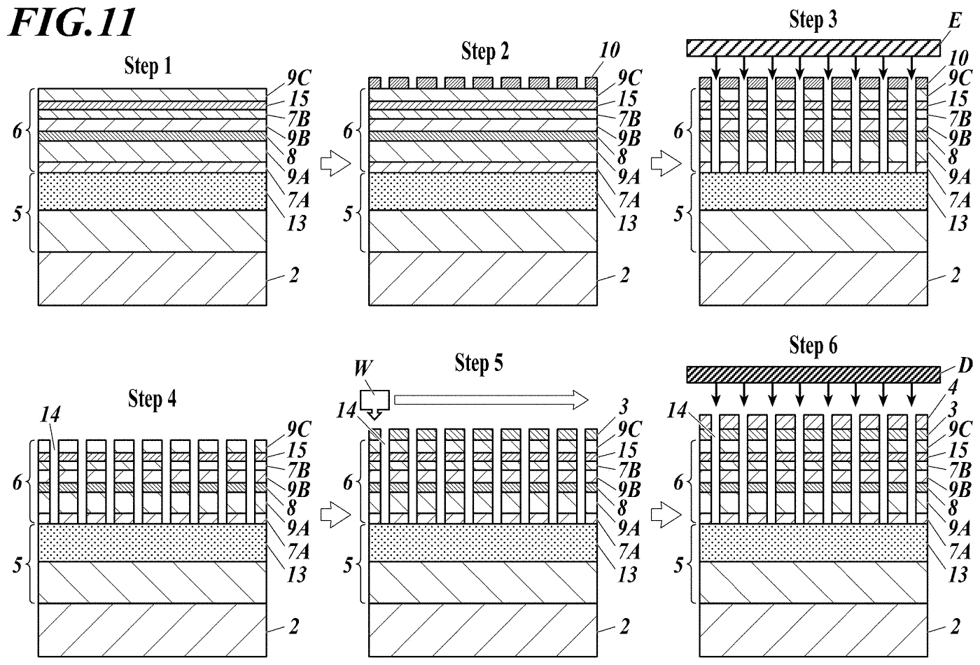

FIG. 11 is a manufacturing flow diagram showing an example of a method of forming pores in a hydrophilic film.

In step 1 of FIG. 11, the hydrophilic film 1 having a structure in which the layers up to the second reflectance control layer unit 6 described in FIG. 10 are laminated is prepared.

Next, in step 2, a metal mask 10 is formed on the surface of the sodium-containing layer 9 (Constituent material=SiO₂—Na₂O, layer thickness=3 nm) which is the uppermost layer of the second reflectance control layer unit 6. The metal mask 10 is composed of a metal portion and an exposed portion. The layer thickness of the metal mask 10 ranges from 1 to 30 nm. Although it depends on the deposition conditions, for example, if the metal mask 10 is deposited so that the layer thickness is 2 nm using a vapor deposition method, it becomes particle-like. Also, for example, if the metal mask 10 is deposited to make the layer thickness 12 to 15 nm using the vapor deposition method, the metal mask 10 tends to be vein-like. Further, for example, when the metal mask 10 is deposited so that the layer thickness is 10 nm using a sputtering method, the metal mask 10 tends to become porous.

In the present invention, the metal mask 10 is preferably formed of, for example, Ag or Al, in particular, formed of silver. The deposition temperature is preferably in the range of 20 to 400° C. and a thickness is preferably in the range of 1 to 30 nm from the viewpoint of controlling the shape of the pores.

Next, in step 3, an etching apparatus E is used to form pores 14 that penetrate from the outermost surface layer to the upper surface of the photocatalyst layer 13 and expose the surface of the photocatalyst layer 13 by etching.

As shown in Step 3, etching is performed by reactive dry etching using an etching apparatus E, or by introducing etching gas into the IAD deposition apparatus. In the pore formation process, etching gases such as CHF₃, CF₄, COF₂ and SF₆ are used as etching gases. Thereby, a plurality of pores 14 are formed in a predetermined size from the outermost surface layer to the upper surface portion of the photocatalyst layer 13 to expose the surface of the photocatalyst layer 13. In other words, the component layer corresponding to the exposed portion of the metal mask 10 is etched to form the pores 14, and the surface of the photocatalyst layer 13 is partially exposed.

Next, the metal mask 10 is removed as step 4. Specifically, the metal mask 10 is removed by wet etching using an agent such as acetic acid, iodine, or potassium iodide. The metal mask 10 may also be removed by dry etching using, for example, Ar or O₂ as the etching gas.

Then, as step 5, on the first reflectance control layer unit 5 and the second reflectance control layer unit 6 in which the pores 14 are formed, a hydrophilic layer is formed using a wet deposition apparatus W so that the layer thickness is 10 nm or less in terms of optical layer thickness. At this time, the hydrophilic layer forming component is applied on the second reflectance control layer unit 6 except for the pores 14, and hardly permeates into the interior of the pores 14.

Finally, as step 6, on the second reflectance control layer unit 6 on which the hydrophilic layer is formed, a dry deposition apparatus D is used to form a protective layer with a layer thickness of 10 nm or less in terms of optical layer thickness. At this time, the protective layer forming component is applied on the hydrophilic layer except for the pores 14, and hardly reaches the interior of the pores 14.

By the above process, a hydrophilic film having a plurality of pores 14 and having an arithmetic mean roughness Ra of 3 nm or more may be obtained.

According to the method for manufacturing the hydrophilic film and the method for forming pores as described above, after forming each constituent layer, by forming a plurality of pores 14 that penetrate from the outermost surface layer to the upper surface of the photocatalyst layer 13 and express the photocatalytic function of the photocatalyst layer, it is possible to achieve both superhydrophilicity and photocatalytic function.

### <<Application of Hydrophilic Film: Optical Members>>

The hydrophilic film of the present invention is a hydrophilic film having low light reflectance, hydrophilic properties and photocatalytic properties, and also having excellent properties such as salt water resistance or scratch resistance. The present invention is characterized by an optical member comprising the hydrophilic film of the present invention, and more preferably, the optical member is a lens, an antibacterial cover member, an anti-mold coating member, or a mirror. For example, it is suitable for automotive lenses, communication lenses, antibacterial lenses for endoscopes, hydrophilic members and antibacterial cover members for PCs and smartphones, glasses, ceramics for toilets and tableware, anti-mold coating for baths and sinks, or building materials (window glass). It is especially suitable for automotive lenses.

### EXAMPLES

Hereinafter, the present invention will be specifically described with examples but the present invention is not limited thereto. In the examples, “part” or “%” is used to indicate “part by mass” or “mass %” unless otherwise specified.

### <<Preparation of Hydrophilic Film>>

### [Preparation of Hydrophilic Film 1]

According to the following method, a hydrophilic film 1 composed of the substrate 2, the first reflectance control layer unit 5, the second reflectance control layer unit 6, and the hydrophilic layer 3 shown in FIG. 6 to FIG. 8 was produced. However, the hydrophilic film 1 has a structure in which the protective layer 4 is removed from FIG. 6.

### [Preparation of Substrate]

As a substrate, a white plate glass substrate (refractive index: 1.523) manufactured by SCHOTT Co. was prepared.

### [Formation of First Reflectance Control Layer Unit 5]

As shown in FIG. 7, the following layers were laminated on the white plate glass substrate from the substrate 2 side by the following vacuum deposition method.

(1) First low refractive index layer 11A (SiO₂, Layer thickness: 22 nm)
(2) High refractive index layer 12 (Ta₂O₅+TiO₂, Layer thickness: 18 nm)
(3) First low refractive index layer 11B (SiO₂, Layer thickness: 33 nm)
(4) Photocatalyst layer 13 (TiO₂, Layer thickness: 112 nm)

The first reflection adjustment layer unit 5 was formed by sequentially stacking the above layers.

The specific deposition conditions are as follows.

### (Deposition Conditions and Apparatus Used)

### <Inside Chamber Conditions>

Heating temperature: 370° C.

Starting vacuum degree: 5.0×10⁻³ Pa

### <Evaporation Source for Film Deposition Materials>

Electron gun

### <IAD Ion Source>

RF Ion Source NIS-175-3 made by SHINCRON Co., Ltd.

### (Formation of First Reflectance Control Layer Unit 5)

### <Formation of First Low Refractive Index Layer 11A>

Film forming material for the first low refractive index layer 11A: SiO₂ (made by Canon Optron Inc., Product name: SiO₂)

The above substrate was placed in the IAD vacuum deposition apparatus, SiO₂ was loaded as the deposition material in the first evaporation source, and deposition was made at a deposition rate 3 Å/sec to form a first low refractive index layer 11A with a layer thickness of 22 nm.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm.

### <Formation of High Refractive Index Layer 12>

Film forming material of high refractive index layer 12: Ta₂O₅—TiO₂ (made by Cannon Optron Inc., Product name: OA-600)

The above film forming material was loaded into the second evaporation source of the IAD vacuum deposition apparatus and deposition was made at a deposition rate of 4 Å/sec. A high refractive index layer 12 with a layer thickness of 22 nm was formed on the above first low refractive index layer 11A.

The high refractive index layer 12 was formed by the IAD method in the same manner as described above, using the heating condition of 370° C. as described above.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm. At this time, O₂ gas was introduced from an auto pressure controller (hereinafter abbreviated as “APC”) so that gas control was performed to keep the chamber pressure to 2×10⁻² Pa.

### <Formation of Second Low Refractive Index Layer 11B>

Film forming material of the second low refractive index layer 11B: SiO₂ (made by Canon Optron Inc., Product name: SiO₂)

The above substrate was placed in the IAD vacuum deposition apparatus, SiO₂ was loaded as the deposition material in the first evaporation source, and deposition was made at the deposition rate 3 Å/sec to form a second low refractive index layer 11B with a layer thickness of 29 nm.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm.

### <Formation of Photocatalyst Layer 13>

Film forming material of photocatalyst layer 13: TiO₂ (made by Fuji Titanium Industries, Ltd., Product name: T.O.P (Ti₃O₅))

The above substrate was placed in an IAD vacuum deposition apparatus, the above film forming material was loaded into the third evaporation source, and deposition was made at a deposition rate of 2 Å/sec to form a photocatalyst layer with a thickness of 112 nm on the above second low refractive index layer 11B. The formation of the photocatalyst layer was performed by the IAD method in the same manner under the heating condition of 370° C.

IAD conditions were as follows: acceleration voltage 300 V, acceleration current 300 mA, suppressor voltage 1000 V, neutralizing current 600 mA, and the LAD introduction gas O₂ with 50 sccm, Ar gas with 10 sccm, neutral gas Ar with 10 sccm. At this time, gas control was performed to keep the chamber pressure at 3×10⁻² Pa by introducing O₂ gas from APC.

### [Formation of Second Reflectance Control Layer Unit 6]

As shown in FIG. 8, a second reflectance control layer unit 6 composed of seven layers was formed on the first reflectance control layer unit 5 produced above by the IAD vacuum deposition method described below.

(1) First low refractive index layer 7A: Constituent material=SiO₂, Layer thickness=90 nm
(2) First sodium-containing layer 9A: Constituent material=SiO₂—Na₂O, layer thickness=14 nm
(3) High refractive index layer 8: Constituent material=TiO₂, Layer thickness=1 nm
(4) Second sodium-containing layer 9B: Constituent material=SiO₂—Na₂O, layer thickness=29 nm
(5) Second low refractive index layer 7B: Constituent material=SiO₂, Layer thickness=1 nm
(6) Salt spray protection layer 15: Constituent material=TiO₂, Layer thickness=1 nm
(7) Third sodium-containing layer 9C: Constituent material=SiO₂—Na₂O, layer thickness=3 nm

### (Deposition Conditions and Apparatus Used)

### <Inside Chamber Conditions>

Heating temperature: 50° C.

Starting vacuum degree: 3.0×10⁻³ Pa

### <Evaporation Source for Film Deposition Materials>

Electron gun

### <IAD Ion Sauce>

RF Ion Source NIS-175-3 made by SHINCRON Co., Ltd.

A second reflectance control layer unit 6 was formed on the first reflectance control layer unit 5 according to the following method.

### <Formation of First Low Refractive Index Layer 7A>

Low refractive index layer deposition material: SiO₂ (made by Canon Optron Inc., Product name: SiO₂)

The substrate formed up to the first reflectance control layer unit 5 was placed in an IAD vacuum deposition apparatus, the second evaporation source was loaded with the aforementioned deposition material, and deposition was made at the deposition rate 3 Å/sec to form a first low refractive index layer 7A with a layer thickness of 14 nm.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm, and the heating condition of 50° C.

### <Formation of First Sodium-Containing Layer 9A>

Film forming material for the first sodium-containing layer 9A: made by Toshima Corporation, Product name: SiO₂—Na₂O (Na content: 5 mass %)

The substrate formed up to the first low refractive index layer 7A was placed in an IAD vacuum deposition apparatus, and the first evaporation source was loaded with the above deposition material for the first sodium-containing layer 9A into the first evaporation source, and evaporation was made at a deposition rate of 3 Å/sec to form a first sodium-containing layer 9A with a layer thickness of 14 nm and a sodium content of 5 mass %.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm, and the heating condition of 50° C.

### <Formation of High Refractive Index Layer 8>

Film forming material for high refractive index layer 8: TiO₂ (made by Fuji Titanium Industries, Ltd., Product name: T.O.P (Ti₃O₅))

The substrate formed up to the first sodium-containing layer 9A was installed in a vacuum evaporation apparatus, the above film forming material was loaded into a third evaporation source, and evaporation was made at a deposition rate of 2 Å/sec to form a high refractive index layer 8 with a thickness of 1 nm on the above first sodium-containing layer 9A. The formation of the high refractive index layer was performed by the IAD method in the same manner under the heating condition of 370° C.

IAD conditions were as follows: acceleration voltage 300 V, acceleration current 300 mA, suppressor voltage 1000 V, neutralizing current 600 mA, and the LAD introduction gas O₂ with 50 sccm, Ar gas with 10 sccm, neutral gas Ar with 10 sccm. At this time, gas control was performed to keep the chamber pressure at 3×10⁻² Pa by introducing O₂ gas from APC.

### <Formation of Second Sodium-Containing Layer 9B>

Film forming material of the second sodium-containing layer 9B: made by Toshima Corporation, Product name: SiO₂—Na₂O (Na content: 10 mass %)

The substrate formed up to the high refractive index layer 8 was placed in an IAD vacuum deposition apparatus, the above deposition material was loaded in the first evaporation source, and deposition was made at a deposition rate of 3 Å/sec to form and a second sodium-containing layer 9B having a thickness of 29 nm with a Na content of 10 mass %.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm, and the heating condition of 50° C.

### <Formation of Second Low Refractive Index Layer 7B>

Film forming material of the second low refractive index layer 7B: SiO₂ (made by Canon Optron Inc., Product name: SiO₂)

The substrate formed up to the second sodium-containing layer 9B was placed in an IAD vacuum deposition apparatus, the second evaporation source was loaded with the aforementioned deposition material into the second evaporation source, and deposition was made at a deposition rate of 3 Å/sec to form the second low refractive index layer 7B with a layer thickness of 1 nm.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm, and the heating condition of 50° C.

### (Formation of Salt Spray Protection Layer 15)

Film formation material for salt spray protection layer 15: TiO₂ (made by Fuji Titanium Industries, Ltd., Product name: T.O.P (Ti₃O₅))

The above film forming material was loaded into the second evaporation source of the IAD vacuum deposition apparatus and deposition was made at a deposition rate of 4 Å/sec to form a salt spray protection layer 15 with a layer thickness of 1 nm on the above second low refractive index layer 7B.

The formation of the salt spray protection layer 15 was carried out by the IAD method in the same manner as described above under the heating condition of 370° C.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm. At this time, O₂ gas was introduced from an auto pressure controller (hereinafter abbreviated as “APC”) so that gas control was performed to keep the chamber pressure to 2×10⁻² Pa.

### <Formation of Third Sodium-Containing Layer 9C>

Film forming material for the third sodium-containing layer 9C: made by Toshima Corporation, Product name: SiO₂—Na₂O (Na content: 10 mass %)

The substrate formed up to the salt spray protection layers 15 was placed in an IAD vacuum deposition apparatus, the above deposition material was loaded in the first evaporation source, and deposition was made at a deposition rate of 3 Å/sec to form a third sodium-containing layer 9C having a layer thickness of 3 nm with a Na content of 10 mass %.

IAD conditions were as follows: acceleration voltage 1000 V, acceleration current 1000 mA, suppressor voltage 500 V, neutralizing current 1500 mA, IAD introduction gas O₂ with 50 sccm, Ar gas with 0 sccm, neutral gas Ar with 10 sccm, and the heating condition of 50° C.

### [Formation of Hydrophilic Layer]

### (Method of Forming Hydrophilic Layer)

A hydrophilic layer was formed on the second reflectance control layer unit according to the following method.

(A) Constituent material: EXCELPURE BD-SO1 (SiO₂—Na₂O, containing 1.4 atm % of Na) made by Central Automotive Products Ltd.
(B) The hydrophilic layer was formed using a known spin-coating method.

First, EXCELPURE was diluted to 8 times with ethanol. Then, using the above-mentioned EXCELPURE diluted solution, 50 μL of the solution was applied on the second reflectance control layer unit at room temperature, at a rotation speed of 3000 rpm to form a hydrophilic layer with a layer thickness of 4 nm. Finally, after the hydrophilic layer was formed, a sintering process was applied at 370° C. for 30 minutes to form the hydrophilic layer 1 as shown in FIG. 6 (however, the formation of the protective layer 4 was not performed).

### [Preparation of Hydrophilic Film 2]

In the preparation of the hydrophilic film 1 above, the formation of the hydrophilic layer was carried out in the same manner, except that instead of the spin coating method, the above-mentioned EXCELPURE diluted solution was dipped into a sponge and then applied on the second reflectance control layer unit by the hand coating method to prepare a hydrophilic film 2.

### [Preparation of Hydrophilic Film 3]

A hydrophilic film 3 was prepared in the same manner as in the preparation of the hydrophilic film 1, except that a protective layer was further formed on the hydrophilic layer according to the following method.

### [Formation of Protective Layer]

A protective layer was formed on the hydrophilic layer according to the following method.

(A) Forming material: made by Toshima Corporation, Product name: SiO₂—Na₂O (Na content: 10.0 atm %)
(B) Deposition process: IAD method

The hydrophilic film 1 formed up to the hydrophilic layer was installed in an IAD vacuum deposition apparatus, the first evaporation source was loaded with the above deposition material, and deposition was made at a deposition rate of 3 Å/sec under the conditions of 370° C. and a vacuum degree of 7.0×10; Pa or less. A protective layer having a layer thickness of 5 nm composed of SiO₂—Na₂O (Na content: 10 atm %) was prepared.

### [Preparation of Hydrophilic Film 4]

In the preparation of the hydrophilic film 3 above, the formation of the hydrophilic layer was carried out in the same manner, except that instead of the spin coating method (wet deposition 1), the above-mentioned EXCELPURE diluted solution was applied on the second reflectance control layer unit using a known dip coater (wet deposition 3). Thus, the hydrophilic film 4 was prepared.

### [Preparation of Hydrophilic Film 5]

In the preparation of the hydrophilic film 3 above, the hydrophilic film 5 was prepared in the same manner, except that the deposition conditions (deposition speed and time) were adjusted appropriately and the layer thickness of the protective layer was changed to 20 nm.

### [Preparation of Hydrophilic Film 6]

In the preparation of the hydrophilic film 3 above, the hydrophilic film 6 was prepared in the same manner, except that the sodium content in the hydrophilic layer was changed to 0.02 atm %.

### [Preparation of Hydrophilic Film 7]

In the preparation of hydrophilic film 3 above, the hydrophilic film 7 was prepared in the same manner, except that the sodium content in the hydrophilic layer was changed to 5.0 atm %.

### [Preparation of Hydrophilic Film 8]

In the preparation of hydrophilic film 3 above, the hydrophilic film 8 was prepared in the same manner, except that the sintering temperature during the formation of the hydrophilic layer was changed from 370° C. to 100° C.

### [Preparation of Hydrophilic Film 9]

In the preparation of hydrophilic film 7 above, the hydrophilic film 9 was prepared in the same manner, except that the temperature of the protective layer was changed from 370° C. to 80° C.

### [Preparation of Hydrophilic Film 10]

In the preparation of the hydrophilic film 3 above, the hydrophilic film 10 was prepared in the same manner, except that the material for the protective layer was changed to HP-3 as shown below.

HP-3: Product name manufactured by Canon Optron Inc., Compositions=C: 13.9 atm %, O: 60.5 atm %, P: 15.4 atm %, Ca: 5.0 atm %, Ce: 5.3 atm %.

### [Preparation of Hydrophilic Film 11]

In the preparation of the hydrophilic film 3 above, the hydrophilic film 11 was prepared in the same manner, except that the second reflectance control layer unit was not formed.

### [Preparation of Hydrophilic Film 12]

In the preparation of the hydrophilic film 3 above, the hydrophilic film 12 was prepared in the same manner, except that the protective layer was formed using SiO₂ alone (e.g., Product name: SiO₂, made by Canon Optron, Inc.), and the sodium-containing layers 9A, 9B and 9C, which constitute the second reflectance control layer unit, were not formed.

### [Preparation of Hydrophilic Film 13]

In the preparation of the hydrophilic film 3 above, the hydrophilic film 13 was prepared in the same manner, except that the pores were formed according to the following method.

### (Pore Formation)

In the preparation of the hydrophilic film 3 above, the pores were formed according to the following method after the formation of the second reflectance control layer unit and before the formation of the hydrophilic layer.

After forming up to the second reflectance control layer unit 6, according to the pore formation method shown in FIG. 11, Ag was used as a mask material, a deposition method was used for forming the mask 10, the mask thickness was set to 20 nm, CHF₃ was used for etching gas, and etching time was set to 60 sec. Under these conditions, the pores 14 shown in FIG. 11 were formed.

The detailed pore formation conditions are as follows.

In step 2 described in FIG. 11, Ag film was deposited using a deposition apparatus (BMC-800T, made by SHINCRON Co., Ltd.), and the Ag mask was formed by depositing the film under the following conditions.

Heating temperature: 180° C.

Starting vacuum degree: 1.33×10⁻³ Pa

Deposition rate: 3 Å/sec

In step 3 described in FIG. 11, an etching apparatus (CE-300I) (made by ULVAC, Inc.) was used to deposit the film under the following conditions. By changing the etching time, the width length of the pores was set to 25 to 50 μm. The depth of the pores 14 was set to the conditions where the interface of the photocatalyst layer 13 was exposed.

Antenna RF: 400 W

Bias RF: 38 W

APC pressure: 0.5 Pa

CHF₃ Flow rate: 20 sccm

Etching time: 60 sec

Then, the silver mask 10 was removed using chemicals as step 4 in FIG. 11.

### [Preparation of Hydrophilic Film 14]

In the preparation of the hydrophilic film 13 above, the hydrophilic film 14 was prepared in the same manner, except that the width of the silver mask at the time of the formation of the pores was set to ½ and the width length of the pores 14 was set to 0.5 μm.

### [Preparation of Hydrophilic Film 15]

In the preparation of the hydrophilic film 12 above, the hydrophilic film 15 was prepared in the same manner, except that the hydrophilic layer and the protective layer were not formed.

### [Preparation of Hydrophilic Film 16]

In the preparation of the hydrophilic film 1 above, the hydrophilic film 16 was prepared in the same manner, except that the formation of the hydrophilic layer was changed to the dry deposition method used in the formation of the hydrophilic film 3.

### [Preparation of Hydrophilic Film 17]

In the preparation of the hydrophilic film 1 above, the hydrophilic film 17 was prepared in the same manner, except that the Na content of the hydrophilic layer was changed to 2.0 atm % and the layer thickness was changed to 140 nm.

### [Determination of Sodium Content in Hydrophilic Layer]

The sodium content (atm %) in the hydrophilic layer used to prepare each of the above hydrophilic films was measured by the following method.

A single layer of the hydrophilic layer for sodium content measurement with a layer thickness of 200 nm was formed on the substrate in the same way as the formation method of the hydrophilic layer, and this was used as the sample for the measurement of sodium content in the hydrophilic layer. The sodium content was measured by XPS composition analysis as shown below.

### (XPS Composition Analysis)

Name of apparatus: X-ray photoelectron spectrometer (XPS)

Apparatus type: Quantera SXM

Apparatus manufacturer: ULVAC Phi

Measurement conditions: X-ray source=Monochromatized AlKα beam 25 W 15 kV

Vacuum degree: 5.0×10⁻⁸ Pa

TABLE I

| | Hydrophilic layer | | | | | | Protective layer | | | | | |
|---|---|---|---|---|---|---|---|---|---|---|---|---|
| | Material | Material | | Layer | | Sintering | Material | Material | | Layer | | Deposition |
| Hydrophilic | 1 | 2 | | thickness | Forming | temperature | 1 | 2 | | thickness | Forming | temperature |
| film No. | Type | Type | *A | (nm) | method | (° C.) | Type | Type | *A | (nm) | method | (° C.) |
| 1 | SiO₂ | Na₂O | 1.4 | 4 | Wet deposition 1 | 370 | — | — | — | — | — | — |
| 2 | SiO₂ | Na₂O | 1.4 | 4 | Wet deposition 2 | 370 | — | — | — | — | — | — |
| 3 | SiO₂ | Na₂O | 1.4 | 4 | Wet deposition 1 | 370 | SiO₂ | Na₂O | 10.0 | 5 | *B | 370 |
| 4 | SiO₂ | Na₂O | 1.4 | 4 | Wet deposition 3 | 370 | SiO₂ | Na₂O | 10.0 | 5 | *B | 370 |
| 5 | SiO₂ | Na₂O | 1.4 | 4 | Wet deposition 1 | 370 | SiO₂ | Na₂O | 10.0 | 20 | *B | 370 |
| 6 | SiO₂ | Na₂O | 0.02 | 4 | Wet deposition 1 | 370 | SiO₂ | Na₂O | 10.0 | 5 | *B | 370 |
| 7 | SiO₂ | Na₂O | 5.0 | 4 | Wet deposition 1 | 370 | SiO₂ | Na₂O | 10.0 | 5 | *B | 370 |
| 8 | SiO₂ | Na₂O | 1.4 | 4 | Wet deposition 1 | 100 | SiO₂ | Na₂O | 10.0 | 5 | *B | 370 |
| 9 | SiO₂ | Na₂O | 5.0 | 4 | Wet deposition 1 | 370 | SiO₂ | Na₂O | 10.0 | 5 | *B | 80 |
| 10 | SiO₂ | Na₂O | 1.4 | 4 | Wet deposition 1 | 370 | HP-3 | — | — | 5 | *B | 370 |
| 11 | SiO₂ | Na₂O | 1.4 | 4 | Wet deposition 1 | 370 | SiO₂ | Na₂O | 10.0 | 5 | *B | 370 |
| 12 | SiO₂ | Na₂O | 1.4 | 4 | Wet deposition 1 | 370 | SiO₂ | — | — | 5 | *B | 370 |
| 13 | SiO₂ | Na₂O | 1.4 | 4 | Wet deposition 1 | 370 | SiO₂ | Na₂O | 10.0 | 5 | *B | 370 |
| 14 | SiO₂ | Na₂O | 1.4 | 4 | Wet deposition 1 | 370 | SiO₂ | Na₂O | 10.0 | 5 | *B | 370 |
| 15 | — | — | — | — | — | — | — | — | — | — | — | — |
| 16 | SiO₂ | Na₂O | 1.4 | 4 | Dry deposition | — | — | — | — | — | — | — |
| 17 | SiO₂ | Na₂O | 2.0 | 140 | Wet deposition 1 | — | — | — | — | — | — | — |

| | Reflectance control layer unit | | | | |
|---|---|---|---|---|---|
| Hydrophilic | Presence | Presence or absence of | Presence or | Arithmetic mean | |
| film No. | or absence | Na-containing layer | absence of pores | roughness Ra (nm) | Remarks |
| 1 | Present | Present | Absent | 6.3 | Present Invention |
| 2 | Present | Present | Absent | 9.0 | Present Invention |
| 3 | Present | Present | Absent | 5.9 | Present Invention |
| 4 | Present | Present | Absent | 5.6 | Present Invention |
| 5 | Present | Present | Absent | 3.0 | Present Invention |
| 6 | Present | Present | Absent | 5.0 | Present Invention |
| 7 | Present | Present | Absent | 7.0 | Present Invention |
| 8 | Present | Present | Absent | 6.3 | Present Invention |
| 9 | Present | Present | Absent | 7.2 | Present Invention |
| 10 | Present | Present | Absent | 6.3 | Present Invention |
| 11 | Absent | Absent | Absent | 6.0 | Present Invention |
| 12 | Present | Absent | Absent | 6.0 | Present Invention |
| 13 | Present | Present | Present | 29.0 | Present Invention |
| 14 | Present | Present | Present | 40.0 | Present Invention |
| 15 | Present | Absent | Absent | 0.4 | Present Invention |
| 16 | Present | Present | Absent | 0.8 | Comparative Example |
| 17 | Present | Absent | Absent | 2.0 | Comparative Example |

*A: Sodium-content (atm %)
Wet deposition 1: Spin coating
Wet deposition 2: Hand coating method
Wet deposition 3: Dip coating
*B: Dry deposition

### <<Evaluation of Hydrophilic Film>>

[Measurement of arithmetic mean roughness Ra] The arithmetic mean roughness Ra of each hydrophilic film prepared above was measured in accordance with JIS B 0601-2001, and it was measured using an atomic force microscope (AFM) manufactured by Seiko Instruments Inc.

### [Evaluation of Initial Performance]

### (Evaluation of Initial Hydrophilicity)

The contact angle A of each hydrophilic film prepared above was measured according to the method specified in JIS R3257, as described in the following method.

Using a contact angle measuring apparatus G-1 (made by ELMA Electronic Inc.), 10 μL of pure water was dropped onto the hydrophilic film surface under 23° C., 50% RH, and the static contact angle was measured at 5 seconds after the drop, which was defined as the contact angle A.

The measured contact angles A were then ranked according to the following criteria.

Double circle: Contact angle A is less than 10°.

Circle: Contact angle A is 10° or more, and less than 30°.

Triangle: Contact angle A is 300 or more, and less than 60°.

Cross mark: Contact angle A is 600 or more.

### (Evaluation of Initial Optical Performance: Measurement of Average Light Reflectance)

The average light reflectance of the above fabricated hydrophilic films in the wavelength range of 450 to 780 nm was measured using a micro-area spectral reflectance measurement apparatus USPM-RU manufactured by Olympus Corporation. The obtained average reflectance was evaluated according to the following ranks. When the rank was “Triangle”, “Circle”, or “Double circle”, it was judged to be acceptable for practical use.

Double circle: Average light reflectance is less than 3.0%.

Circle: Average light reflectance is 3.0% or more, and less than 5.0%.

Triangle: Average light reflectance is 5.0% or more, and less than 8.0%.

Cross mark: Average light reflectance is 8.0% or more.

### [Environmental Performance]

### (Forced Degradation Treatment)

### <Treatment 1: High Temperature and High Humidity Treatment>

After leaving each hydrophilic film in a high temperature and high humidity (85° C., 85% RH) environment for 10 to 1000 hours, the time required for the contact angle B to be maintained at 30° or less by the contact angle measurement described above was measured and ranked according to the following conditions.

Double circle: Contact angle B remains less than 30° after 1000 hours

Circle: Contact angle B remains less than 30° for more than 500 hours and less than 1000 hours.

Triangle: Contact angle B remains less than 30° for more than 100 hours and less than 500 hours

Cross mark: Contact angle B remains at 30° for less than 100 hours.

### <Treatment 2: Thermal Shock Treatment (Heat Cycle Resistance)>

The hydrophilic film was maintained at 65° C. for 4 hours as a high temperature environment, and then the temperature was lowered from 65° C. to −15° C. under the condition of 1° C./1 minute. After that, the temperature was maintained at −15° C. for 4 hours as the cryogenic environment, and then the temperature was raised to 65° C. under the condition of 1° C./1 minute, and this cycle was repeated from 0 to 6 cycles.

The contact angle C was then measured in the same manner as described above for each cycle, and the number of cycles in which the contact angle C could be maintained at 15° or less was determined, and the heat cycle resistance was evaluated according to the following criteria.

Double circle: Contact angle C was less than 20° even after 6 cycles

Circle: Contact angle C was less than 20° for 3 cycles or more and 5 cycles or less.

Triangle: Contact angle C was 20° or less for 1 cycle or more and 2 cycles or less.

Cross mark: Contact angle C exceeded 20° even in one cycle.

### (Scratch Resistance Evaluation)

After conducting three cycles of heat cycle treatment using the above method, the contact angle and average light reflectance of the hydrophilic film surface were measured after the surface was rubbed back and forth 30 times using a sheet of KimWipes wetted with water to evaluate the scratch resistance.

### <Evaluation of Hydrophilicity>

The contact angle D of each hydrophilic film surface after abrasion treatment was measured in the same manner as described above and ranked according to the following criteria.

Double circle: Contact angle D is less than 10°.

Circle: Contact angle D is 10° or more, and less than 30°.

Triangle: Contact angle D is 30° or more, and less than 60°.

Cross mark: Contact angle D is 60° or more.

### <Evaluation of Surface Optical Performance>

The average light reflectance of each hydrophilic film after abrasion treatment was measured in the same manner as described above at wavelengths from 450 to 780 nm. The obtained average reflectance was evaluated according to the following ranks. If it was “Triangle”, “Circle” or “Double circle”, it was judged to be acceptable for practical use.

Double circle: Average light reflectance is less than 3.0%.

Circle: Average light reflectance is 3.0% or more, and less than 5.0%.

Triangle: Average light reflectance is 5.0% or more, and less than 8.0%.

Cross mark: Average light reflectance is 8.0% or more.

### (Evaluation of Photocatalytic Function)

The surface of each hydrophilic film was marked with Magic ink (The Visualiser, made by Inkintelligen Co., Ltd.) and stored for 10 hours at 85° C. and 85% RH. After 10 hours of storage at 85° C. and 85% RH, the films were irradiated with ultraviolet rays at 20° C. and 80% RH under the condition that the cumulative does was 20 J. If the magic ink on the surface of the hydrophilic film disappeared, the photocatalytic function was judged as “Present”.

The results obtained from the above are shown in Table II.

TABLE II

| | | | After | | | | | |
|---|---|---|---|---|---|---|---|---|
| | | | environmental | | | | | |
| | | | resistance test | | | | | |
| | | | Forced | | | | | |
| | | | degradation | | After scratch | | Presence or | |
| | Initial performance | | conditions | | resistance test | | absence of | |
| Hydrophilic | | Optical | 85° C. | Heat | | Optical | photocatalytic | |
| film No. | Hydrophilicity | performance | 85% RH | shock | Hydrophilicity | performance | function | Remarks |
| 1 | ⊚ | ⊚ | ⊚ | ⊚ | ◯ | ⊚ | Absent | Present Invention |
| 2 | ⊚ | Δ | ⊚ | ⊚ | ◯ | Δ | Absent | Present Invention |
| 3 | ⊚ | ⊚ | ⊚ | ⊚ | ⊚ | ⊚ | Absent | Present Invention |
| 4 | ⊚ | ⊚ | ⊚ | ⊚ | ⊚ | ⊚ | Absent | Present Invention |
| 5 | ◯ | ⊚ | ◯ | Δ | ⊚ | ⊚ | Absent | Present Invention |
| 6 | ◯ | ⊚ | Δ | ◯ | ⊚ | ⊚ | Absent | Present Invention |
| 7 | ◯ | ⊚ | ◯ | Δ | ⊚ | ⊚ | Absent | Present Invention |
| 8 | ⊚ | ⊚ | ⊚ | ⊚ | Δ | Δ | Absent | Present Invention |
| 9 | ⊚ | ⊚ | ⊚ | ⊚ | ◯ | Δ | Absent | Present Invention |
| 10 | ◯ | ⊚ | Δ | Δ | ⊚ | ⊚ | Absent | Present Invention |
| 11 | ⊚ | Δ | ⊚ | ⊚ | ⊚ | Δ | Absent | Present Invention |
| 12 | ◯ | ⊚ | Δ | ◯ | ⊚ | ⊚ | Absent | Present Invention |
| 13 | ⊚ | ⊚ | ⊚ | ⊚ | ⊚ | ⊚ | Present | Present Invention |
| 14 | ⊚ | ◯ | ⊚ | ⊚ | ◯ | ◯ | Present | Present Invention |
| 15 | X | ⊚ | X | X | ◯ | ⊚ | Absent | Comparative Example |
| 16 | Δ | ⊚ | Δ | X | ⊚ | ⊚ | Absent | Comparative Example |
| 17 | ⊚ | Δ | ⊚ | ⊚ | X | X | Absent | Comparative Example |

As can be seen from the results described in Table II, the hydrophilic films of the present invention have superior optical performance, heat cycle resistance and high temperature and high humidity resistance, and superior surface abrasion resistance properties compared to the comparative examples. Furthermore, the hydrophilic films 12 and 13 with pores penetrating from the surface portion to the top portion of the photocatalyst layer were found to have excellent photocatalytic functions.

### INDUSTRIAL APPLICABILITY

The hydrophilic film produced by the method for manufacturing the hydrophilic film of the present invention has excellent durability, abrasion resistance, and anti-reflection function, and is suitable for application to optical members such as lenses, antibacterial cover members, anti-mold coating members or mirrors.

### DESCRIPTION OF SYMBOLS

1: Hydrophilic film
2: Substrate
3: Hydrophilic layer
4: Protective layer
5: First reflectance control layer unit
6: Second reflectance control layer unit
7, 7A, 7B: Low refractive index layer
8, 12: High refractive index layer
9, 9A, 9B, 9C: Sodium-containing layer
10: Mask (metal mask)
11A: First low refractive index layer
11B: Second low refractive index layer
13: Photocatalyst layer
14: Pore
15: Salt spray protection layer
D: Dry deposition apparatus
E: Etching apparatus
U: Reflectance control layer unit
W: Wet deposition apparatus
101: IAD deposition apparatus
102: Chamber
103: Dome
104: Substrate
105: Deposition source
106: Deposition material
107: IAD ion source
108: Ion beam

1. A method for manufacturing a hydrophilic film, comprising a step of forming a hydrophilic layer mainly composed of SiO₂ on a substrate, wherein at least one hydrophilic layer is formed on the substrate by a wet deposition method so that a layer thickness after drying is 10 nm or less in terms of optical layer thickness, and an arithmetic mean roughness Ra of the hydrophilic film is 3 nm or more.

2. The method for manufacturing a hydrophilic film according to claim 1, wherein the wet deposition method is a spin coating method, a dip coating method, or a spray coating method.

3. The method for manufacturing a hydrophilic film according to claim 1, wherein a protective layer having a layer thickness of 10 nm or less in terms of optical layer thickness is formed on the hydrophilic layer by a dry deposition method.

4. The method for manufacturing a hydrophilic film according to claim 1, wherein the hydrophilic layer contains sodium atoms in the range of 0.1 to 3.0 atm %.

5. The method for manufacturing a hydrophilic film according to claim 1, wherein after forming the hydrophilic layer by a wet deposition method, the hydrophilic layer is subjected to a sintering process at a temperature of 200° C. or higher.

6. The method for manufacturing a hydrophilic film according to claim 1, wherein the protective layer is mainly composed of SiO₂.

7. The method for manufacturing a hydrophilic film according to claim 3, wherein the protective layer is formed by a dry deposition method at a temperature of 200° C. or higher.

8. The method for manufacturing a hydrophilic film according to claim 1, wherein at least one reflectance control layer unit is formed between the substrate and the hydrophilic layer, and an average light reflectance of the hydrophilic film in the wavelength range of 450 to 780 nm is made to be 3.0% or less.

9. The method for manufacturing a hydrophilic film according to claim 8, wherein at least one layer constituting the reflectance control layer unit is a sodium-containing layer.

10. The method for manufacturing a hydrophilic film according to claim 8, wherein the reflectance control layer unit on the substrate is composed of:
a first reflectance control layer unit containing at least one low refractive index layer and at least one high refractive index layer; and
a second reflectance control layer unit containing at least a low refractive index layer, a high refractive index layer, and a sodium-containing layer, in that order, and, a layer located at a farthest position from the substrate of the first reflectance control layer unit is a photocatalyst layer containing a metal oxide having a photocatalytic function.

11. The method for manufacturing a hydrophilic film according to claim 10, comprising a step of exposing a surface of the photocatalyst layer to form pores.

12. A hydrophilic film having at least a hydrophilic layer on a substrate, wherein the hydrophilic layer is mainly composed of SiO₂, a layer thickness after drying is 10 nm or less in terms of optical layer thickness, and an arithmetic mean roughness Ra of the hydrophilic film is 3 nm or more.

13. The hydrophilic film according to claim 12, having a protective layer of 10 nm or less in terms of optical layer thickness on the hydrophilic layer.

14. The hydrophilic film according to claim 12, wherein the hydrophilic layer contains sodium atoms in the range of 0.1 to 3.0 atm %.

15. The hydrophilic film according to claim 12, wherein the protective layer is mainly composed of SiO₂.

16. The hydrophilic film according to claim 12, having at least one reflectance control layer unit between the substrate and the hydrophilic layer, wherein an average light reflectance of the hydrophilic film in the wavelength range of 450 to 780 nm is 3.0% or less.

17. The hydrophilic film according to claim 16, wherein at least one layer constituting the reflectance control layer unit is a sodium-containing layer.

18. The hydrophilic film according to claim 16, wherein the reflectance control layer unit is composed of:
a first reflectance control layer unit containing at least one low refractive index layer and at least one high refractive index layer; and
a second reflectance control layer unit containing at least a low refractive index layer, a high refractive index layer, and a sodium-containing layer, in that order, and a layer located at a farthest position from the substrate of the first reflectance control layer unit is a photocatalyst layer containing a metal oxide having a photocatalytic function.

19. The hydrophilic film according to claim 18, having pores which penetrate from an outermost surface layer to an upper surface portion of the photocatalyst layer, and expose a surface of the photocatalyst layer.

20. An optical member provided with the hydrophilic film according to claim 12.

21. The optical member according to claim 20, being a lens, an antibacterial cover member, an anti-mold coating member, or a mirror.
